(19) United States
(12) Patent Application Publication
(10) Pub. No.: US 2019/0236495 A1
(43) Pub. Date: Aug. 1, 2019

(54) METHODS AND SYSTEMS FOR CHECKING IN AND OUT GUESTS

(71) Applicant: Hyatt Corporation, Chicago, IL (US)

(72) Inventors: Kimberly Kay Krause, Darien, IL (US); Brett Nelson Cowell, Lisle, IL (US)

(21) Appl. No.: 16/260,337

(22) Filed: Jan. 29, 2019

Related U.S. Application Data
(60) Provisional application No. 62/623,181, filed on Jan. 29, 2018.

(51) Int. Cl. G06Q 10/02; G06F 3/0482; G06Q 50/12; G06F 3/0484

(52) U.S. Cl. CPC G06Q 10/02; G06F 3/04845; G06Q 50/12; G06F 3/0482

(57) ABSTRACT

The application describes a networked computing system including a non-transitory memory and processor including an application where a user can search and view a customer's name for an existing reservation displayed on a graphical user interface of an application. The GUI also displays relevant information including previous stays, preferences and other interesting notes about the customer in a single interface. The GUI displays rooms at a place of hospitality in the single interface. One or more available rooms may be selected via the GUI and may be locked for a guest until the room is reserved or the room is caused to be unlocked.

### CROSS REFERENCE TO RELATED APPLICATIONS

This application claims the benefit of U.S. Provisional Patent Application No. 62/623,181, filed Jan. 29, 2018, which is hereby incorporated by reference in its entirety.

### FIELD

The present application is directed to applications that improve the check-in and check-out experience at a lodging facility.

### BACKGROUND

Presently, the time necessary to check-in and check-out customers at hotels is excessively long. Once a valued customer reaches the front desk, the host must go through multiple screens and iterations to locate the customer's reservation, previous stays, preferences, and interesting notes. Scrolling between multiple screens results in longer customer wait times, and in some cases, may cause the host to be unable to view important customer information before commencing the check-in process. In the hospitality industry where customer experience is paramount, such setbacks could result in the loss of clientele.

Meeting all of a customer's room requests in an efficient manner can be difficult. Current reservation systems require hosts to review each customer request sequentially. In other words, if the customer has multiple requests, i.e., room type, view, and location, the host must scroll between multiple screens for each request. These procedures not only take longer to execute, but may also result in the customer not receiving the ideal room based upon existing availability.

Unknowingly assigning a room to a customer simultaneously being advertised to another customer is common in today's reservation systems. That is, hosts are unaware of their colleagues holding rooms for other customers. When the room is unknowingly assigned to one customer, it is natural that the other customer will be disappointed. Techniques to reduce client dissatisfaction our needed in today's competitive hospitality industry.

Arriving at the wrong hotel can prove challenging in view of existing reservation systems. Namely, if the customer's information does not show up in the hotel's reservation system, the host has no way of determining which other hotel the customer's reservation is at. Systems and techniques to retrieve a customer's reservation booked at another hotel is desired.

Providing valued customers with the best room available is contingent upon timing. Currently, if a customer's assigned room is not available or there are no rooms available at the hotel, the customer cannot be checked in. What is desired is an efficient queuing system to alert customers and hosts when the room is ready.

### SUMMARY

This summary is provided to introduce a selection of concepts in a simplified form that are further described below in the Detailed Description. This Summary is not intended to limit the scope of the claimed subject matter. The foregoing needs are met, to a great extent, by the present application directed to a process and system for enhancing customer experience at a lodging facility

In one aspect of the application, a networked computing system is described including a non-transitory memory and processor including an application where a user can search and view a customer's name for an existing reservation on an application including a graphical user interface (GUI). The GUI displays relevant information including previous stays, preferences, other interesting notes about the customer, and rooms in a single interface. The application minimizes the amount of time a host requires to locate relevant information.

In another aspect of the application, a networked computing system is described including a non-transitory memory and processor including an application where a user can search and locate rooms in a single interface, based upon plural requests and criteria, displayed on a GUI of the application to offer a customer at a lodging facility. The application also provides fees to upsell rooms. These features help ensure improved customer satisfaction.

In yet another aspect of the application, a networked computing system is described including a non-transitory memory and processor including an application where a user can lock available rooms being reserved for a customer on a GUI of the application. Moreover, another user can view the room's locked status on the GUI. This prevents checking in another customer to the locked room.

In yet even another aspect of the application, a networked computing system is described including a non-transitory memory and processor including an application for assisting a customer locate a reservation at another lodging facility via a GUI of the application.

In a further aspect of the application, a networked computing system is described including a non-transitory memory and processor including an application for queuing a customer whose room is not available and alerting them when the room is available via a GUI of an application.

There has thus been outlined, rather broadly, certain embodiments of the invention in order that the detailed description thereof may be better understood, and in order that the present contribution to the art may be better appreciated.

### BRIEF DESCRIPTION OF THE DRAWINGS

Aspects of the described methods are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Like numbers refer to like elements throughout. In the drawings:

FIG. 1A illustrates a M2M device on a network.

FIG. 1B illustrates a networked computing system.

FIG. 2A illustrates a GUI including logic for finding a customer reservation.

FIG. 2B illustrates a GUI including relevant information associated with the customer.

FIG. 3 illustrates a GUI including multiple options for selecting a room.

FIGS. 4A and 4B illustrate a GUI including options for blocking a room.

FIGS. 5A-5C illustrate a GUI for locating a customer's reservation for another lodging facility.

FIGS. 6A-6C illustrate a GUI for queuing a customer based on availability of room at the lodging facility.

FIGS. 7-9 illustrate example methods.

### DETAILED DESCRIPTION

A detailed description of the illustrative embodiment will be discussed in reference to various figures, embodiments and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “an aspect” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other.

Generally, a hospitality service may include an area at a place of hospitality, such as a guest room, a fitness facility, a pool area, a spa, a parking area, an entertainment center, a restaurant, a bar, a business center, or a conference center, for example. The hospitality service may include an amenity such as an internet service, a communication service (such as use of a pay phone or a fax machine), a parking privilege, a spa treatment, a class, or an event pass, for example. The hospitality service may be a physical commodity such as food, beverage, or merchandise, for example. A place of hospitality, such as a hotel, a resort, or another lodging facility may limit access to the hospitality service to an authorized guest. The authorized guest may be a guest with a reservation. The authorized guest may be a guest who has provided payment for the hospitality service. The authorized guest may be a guest who is a member of a loyalty program. The authorized guest may be a guest for whom it has been determined access should be granted to the hospitality service.

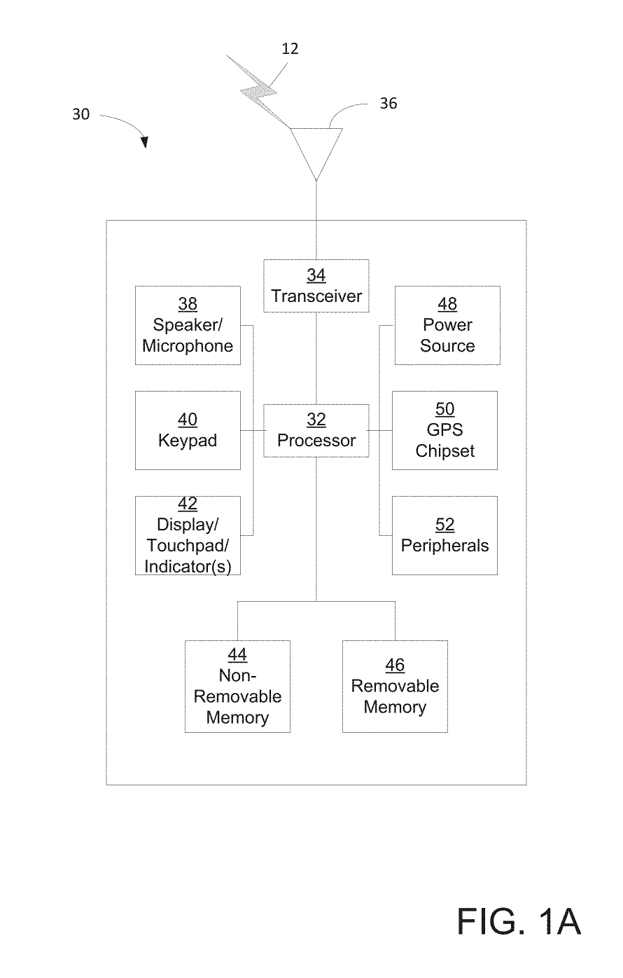

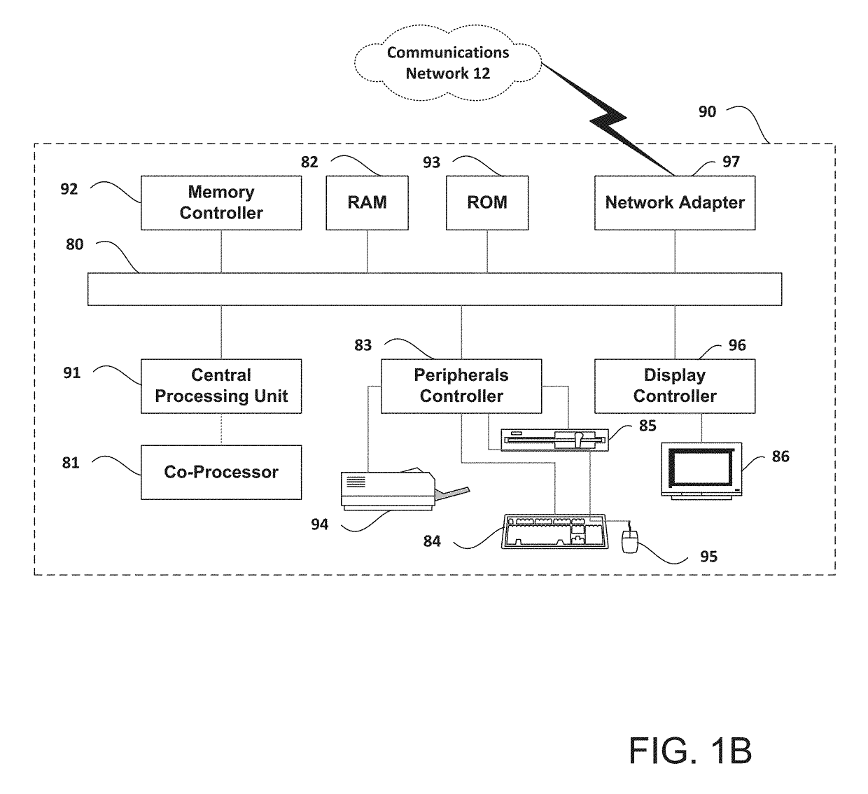

FIG. 1A is a system diagram of an example M2M device 30, such as an M2M terminal device 18 or an M2M gateway device 14 for example. These devices may include hotel reservation systems. The M2M device 30 may be configured to send and receive messages. As shown in FIG. 1A, the M2M device 30 may include a processor 32, a transceiver 34, a transmit/receive element 36, a speaker/microphone 38, a keypad 40, a display/touchpad and/or indicator 42, non-removable memory 44, removable memory 46, a power source 48, a global positioning system (GPS) chipset 50, and other peripherals 52. In one embodiment, the M2M device 30 may be a 6LN, 6BR and/or a 6LBR. It will be appreciated that the M2M device 40 may include any sub-combination of the foregoing elements while remaining consistent with an embodiment. This device may be a device that uses the disclosed systems and methods for embedded semantics naming of sensory data.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, and/or any other functionality that enables the M2M device 30 to operate in a wireless environment. The processor 32 may be coupled to the transceiver 34, which may be coupled to the transmit/receive element 36. While FIG. 1B depicts the processor 32 and the transceiver 34 as separate components, it will be appreciated that the processor 32 and the transceiver 34 may be integrated together in an electronic package or chip. The processor 32 may perform application-layer programs, e.g., browsers, and/or radio access-layer (RAN) programs and/or communications. The processor 32 may perform security operations such as authentication, security key agreement, and/or cryptographic operations, such as at the access-layer and/or application layer for example.

The transmit/receive element 36 may be configured to transmit signals to, or receive signals from, an M2M service platform 22. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 1A as a single element, the M2M device 30 may include any number of transmit/receive elements 36. More specifically, the M2M device 30 may employ MIMO technology. Thus, in an embodiment, the M2M device 30 may include two or more transmit/receive elements 36, e.g., multiple antennas, for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable memory, such as the non-removable memory 44 and/or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the M2M device 30, such as on a server or a home computer.

The processor 32 may receive power from the power source 48, and may be configured to distribute and/or control the power to the other components in the M2M device 30. The power source 48 may be any suitable device for powering the M2M device 30. For example, the power source 48 may include one or more dry cell batteries, e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information, e.g., longitude and latitude, regarding the current location of the M2M device 30. It will be appreciated that the M2M device 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1B is a block diagram of an exemplary computing system 90. Computing system 90 may comprise a computer or server and may be controlled primarily by computer readable instructions, which may be in the form of software, wherever, or by whatever means such software is stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91 that performs additional functions or assists CPU 91. CPU 91 and/or coprocessor 81 may receive, generate, and process data related to the disclosed systems and methods for embedded semantic naming, such as queries for sensory data with embedded semantic names.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86. Display 86, may display sensory data in files or folders using embedded semantics names.

Further, computing system 90 may contain network adaptor 97 that may be used to connect computing system 90 to an external communications network, such as network 12.

According to the present application, it is understood that any or all of the systems, methods and processes described herein may be embodied in the form of computer executable instructions, e.g., program code, stored on a computer-readable storage medium which instructions, when executed by a machine, such as a computer, server, M2M terminal device, M2M gateway device, or the like, perform and/or implement the systems, methods and processes described herein. Specifically, any of the steps, operations, or functions described above may be implemented in the form of such computer executable instructions. Computer readable storage media include volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other physical medium which can be used to store the desired information and which can be accessed by a computer.

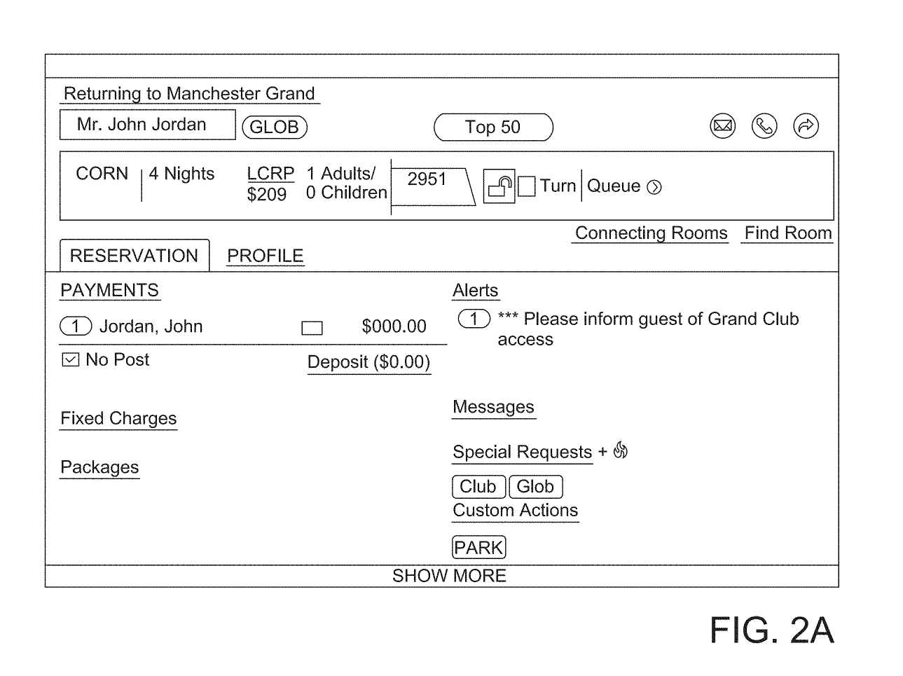

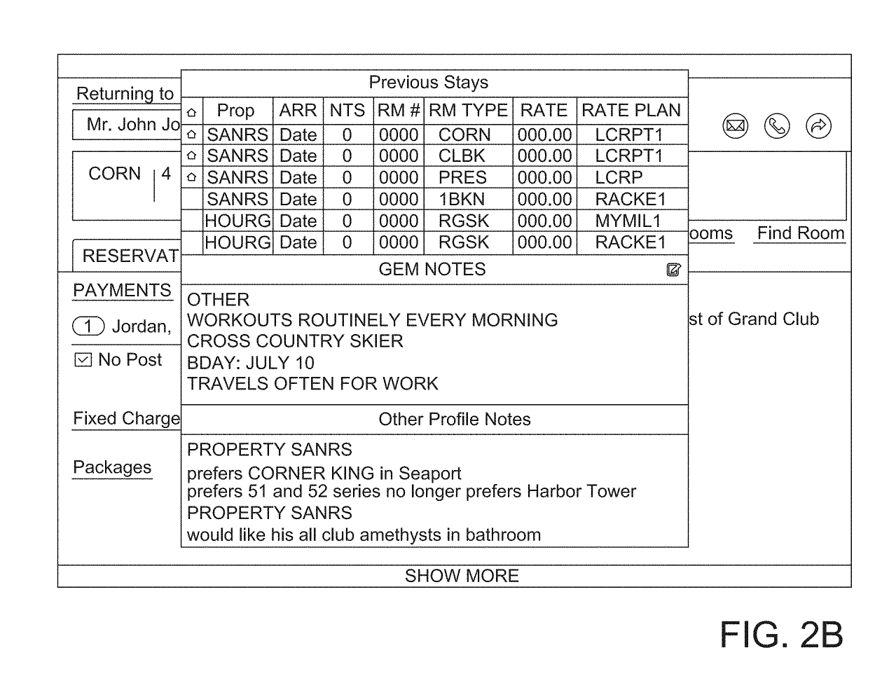

According to an aspect of the application, FIG. 2 illustrates a networked computing system, such as for example a device in FIG. 1A or 1B, upon which a GUI of an application is displayed. Specifically, the GUI illustrates a search box for inputting a customer/guest's first and/or last name. Searching for the first and/or last names helps locate the customer quicker. Conventional architectures can only search by first or last names. Therefore, if the host is searching for “Jordan,” all hits would populate and require an additional step of searching for John Jordan.

The application searches reservations based upon the name at the specific lodging facility. In this example, the lodging facility is the SANRS Manchester Grand. The application is able to locate Mr. John Jordan's reservation. Reservation information may be provided on the GUI. The reservation information may include a number of nights, a room location, a bed size, reservation dates, a price, and a number of guests, as examples. In addition to providing the reservation information, alerts, messages and special requests are also offered. Custom actions are also provided on the GUI to help with check-in. For instance, a parking option is provided to help reduce the time it takes to configure the key for a parking gate and ensure parking charges are correctly put on the guest account.

FIG. 2B exemplarily illustrates useful information about the customer including previous stays, preferences on room types and other useful information. This information is all located on one simple user interface. By so doing, the host is able to quickly familiarize herself with the customer in order to have a meaningful communication. This avoids having to locate information across different applications/services. For example, FIG. 2B illustrates information about previous stays at one or more properties and the types of rooms preferred. The host is able to quickly scan the information and make room selections accordingly to ensure a smooth check-in process for the guest.

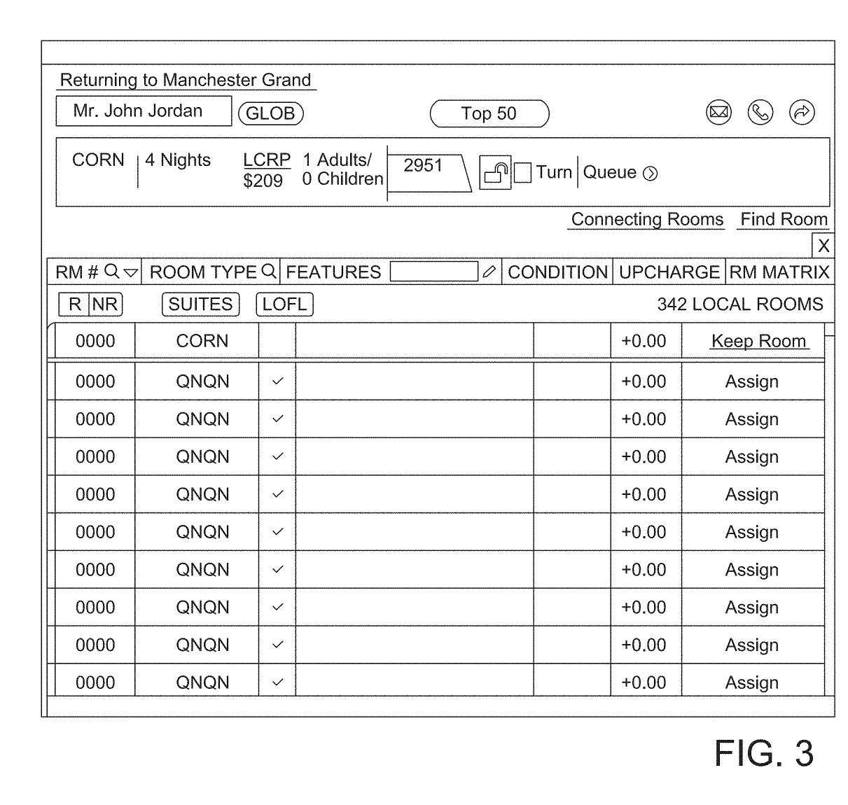

According to another aspect, FIG. 3 illustrates a reservation application on a computing system whereby a host is able to view one or more room preferences to offer a client. As shown in FIG. 3, one of the preferences listed under room type is Suites. All ready and non-ready rooms designated as Suites in the system are populated. As illustrated in the GUI of the reservation application, the non-ready Suite is room 2951. The ready Suites are listed below room 2951. As shown, the ready suites may be separated from the non-ready suites by a divider or other demarcation. Alternatively, the ready suites may appear on the GUI in a specific color, e.g., green, distinct from the non-ready suites, e.g., red. Therefore, depending upon the time a guest wishes to occupy a room, a non-ready suite may be still be an option. The type of Suite is also listed, including for example, corner, queen, connecting queen, king, etc. Rooms that are sold out are indicated next to the Suite type. For example, rooms 0851 and 0602 are illustrated as being sold out.

Next, a preference for low floor rooms “LOFL” is provided. All rooms that are ready to be assigned and meet the requirements of Suite and LOFL are denoted by a check mark. Importantly, the GUI continues to display room 2951. This helps the host advise the customer of all available rooms in case the customer prefers as a first option, a corner room over a connecting queen, with the second option being the floor.

FIG. 3 also provides an UPCHARGE column. Here, if one or more of the rooms exceeds the room reservation charge, the UPCHARGE price would be indicated here. This feature allows guests to pay a premium for rooms that meet more than one room preference type. All of the information is listed on one screen such that the host does not need to switch back and forth to other pages in order to check prices for other rooms.

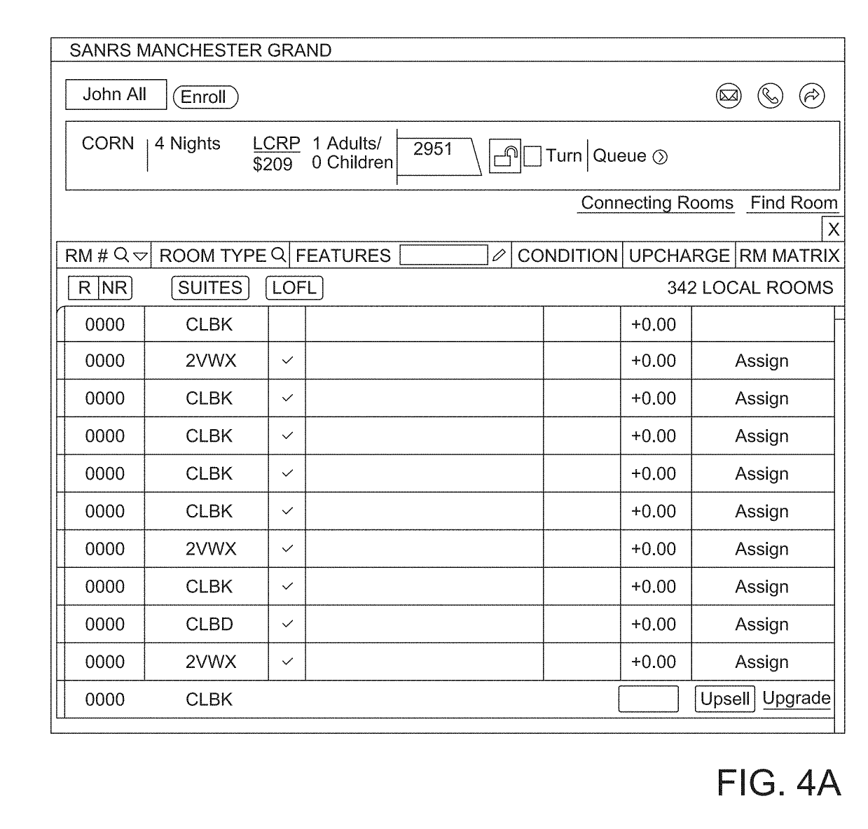

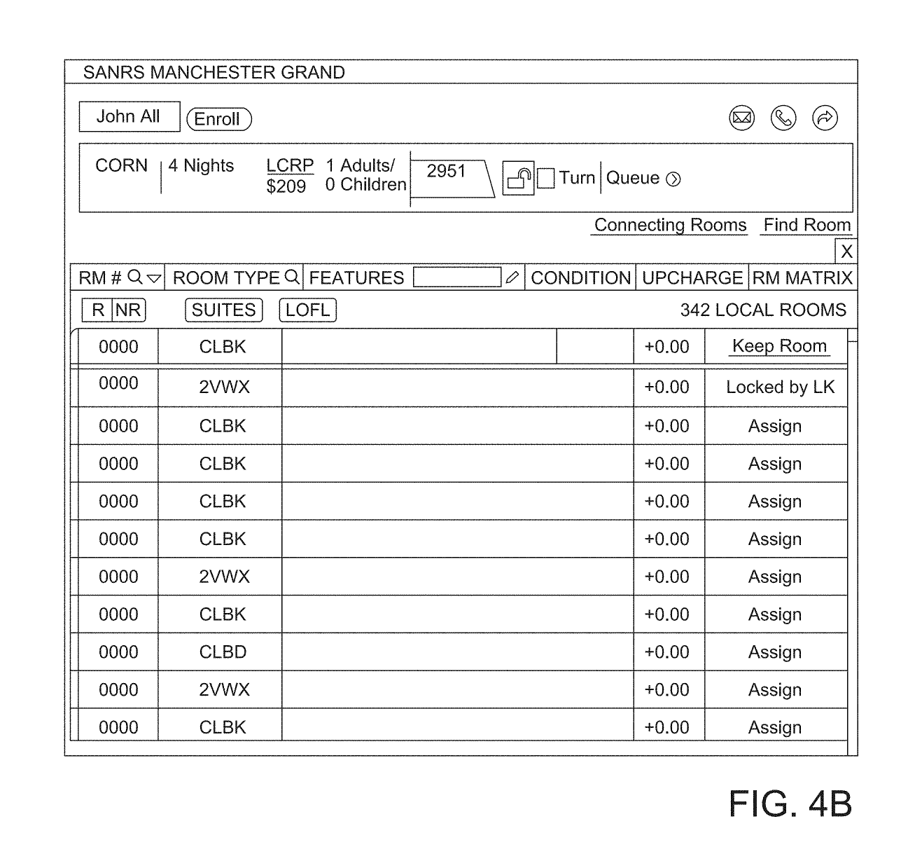

According to another aspect of the application, FIG. 4A exemplarily illustrates an application including a GUI whereby rooms to be assigned are displayed. Conventional architectures do not offer options to allow a host to hold rooms while completing a room selection for a customer. In other words, two hosts servicing two separate customers conceivably could be trying to book the same room. The current application allows hosts to view which rooms are locked and by which host. This is exemplarily illustrated in FIG. 4B. The application reduces the likelihood that a host guarantees a specific room to customer and the room is assigned by another host to a different customer.

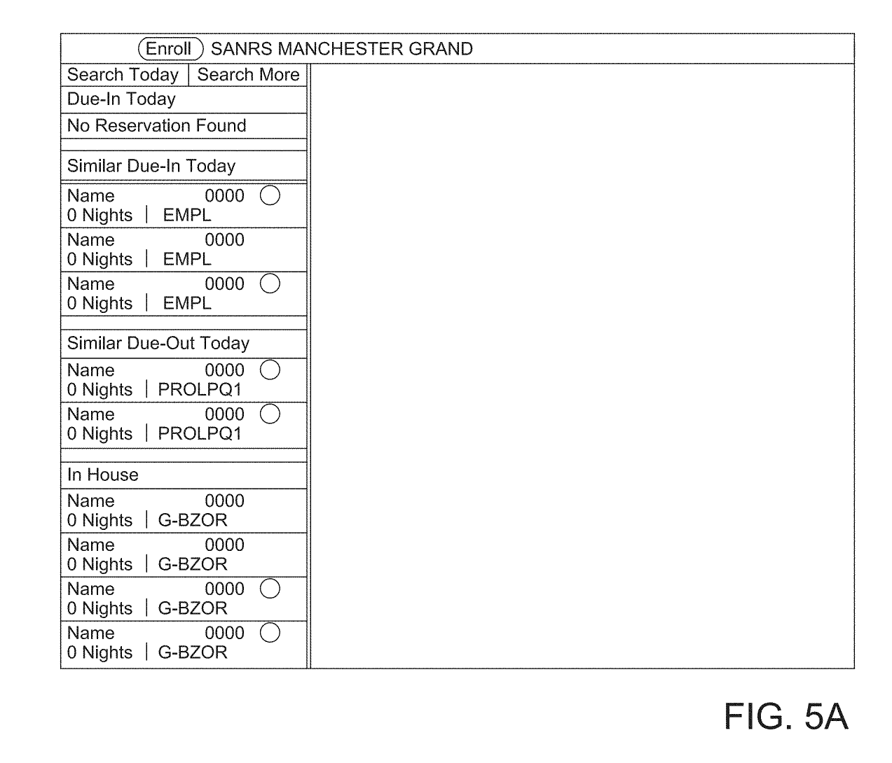

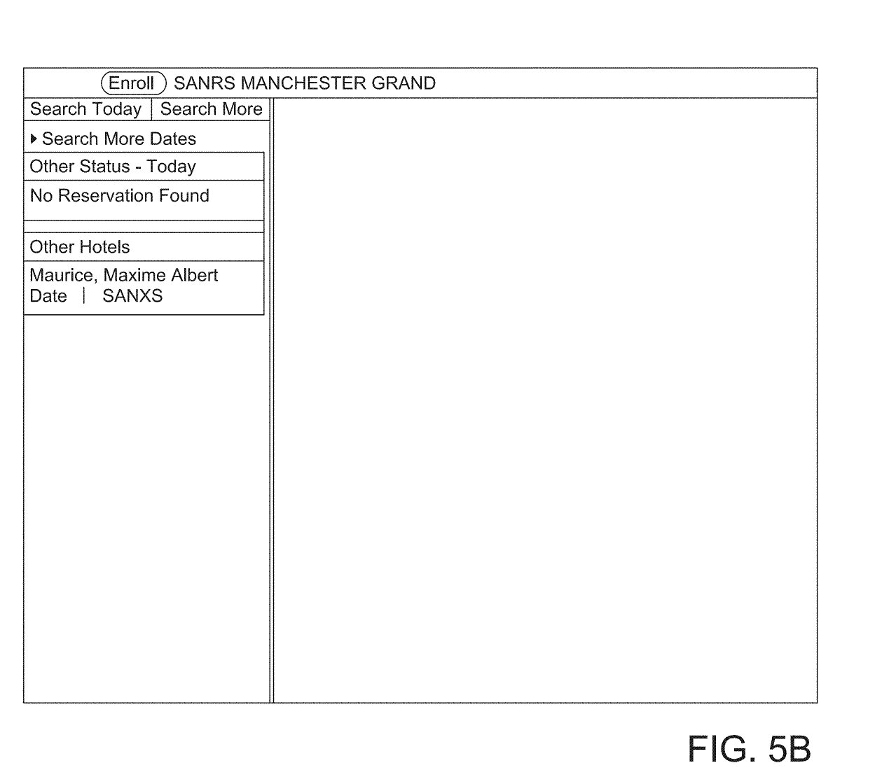

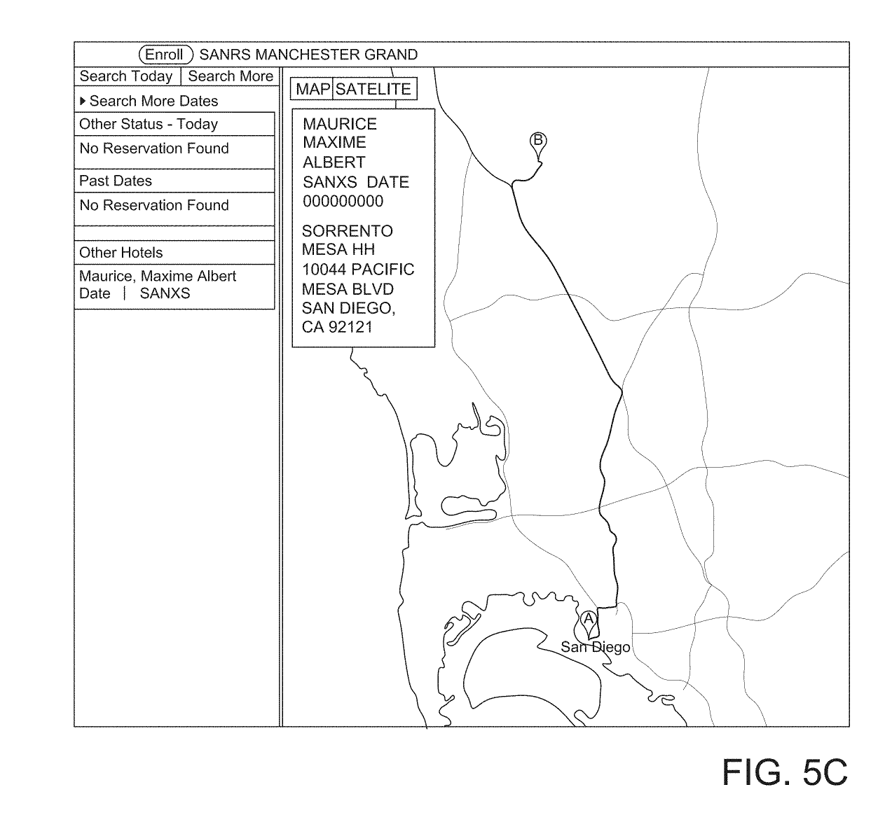

According to yet another aspect of the application, FIG. 5A illustrates an application including a GUI whereby a host can search for a reservation of a guest due in at the current hotel or at another location. As shown in FIG. 5A, the GUI may show guests that are expected to check-in or check-out at a specific location on a specific date. The GUI may show guests that are currently staying at the specific location on the specific date. Sometimes, a customers may not recall if they are checked in at a specific hotel. This can occur, for example, when multiple hotels of the same chain are densely located in a specific area such as New York or southern California. In such situations, a search may be performed by a host. For example, in FIG. 5A, when a guest named “Maxime Albert Maurice” arrives at the front desk to check-in, the host can search the first and/or last name. Here, the host searches by the guest's last name Maurice. All reservations at the specific hotel, i.e., SANRS Manchester Grand, that are due in today, due-out today, currently in-house, and other similar reservations are populated on the GUI of the reservation application. However, the last name Maurice does not populate any results under “Search Today.”

Next, the host can search for the last name Maurice under the tab “Search More” as exemplarily illustrated in FIG. 5B. While Maurice does not populate at the SANRS Manchester Grand Hotel for today, or past date, the reservation is successfully found at another hotel. The host can provide the customer with his or her reservation details and directions to the hotel location in relation to the current hotel as shown in FIG. 5C. For example, the GUI may show an address of one or more of the hotels. The GUI may show a map illustrating the location of the current hotel and the location of the hotel associated with the reservation. The map may provide directions or a suggested route from the current hotel to the hotel associated with the reservation. Alternatively, the host can offer to rebook the customer at the current location.

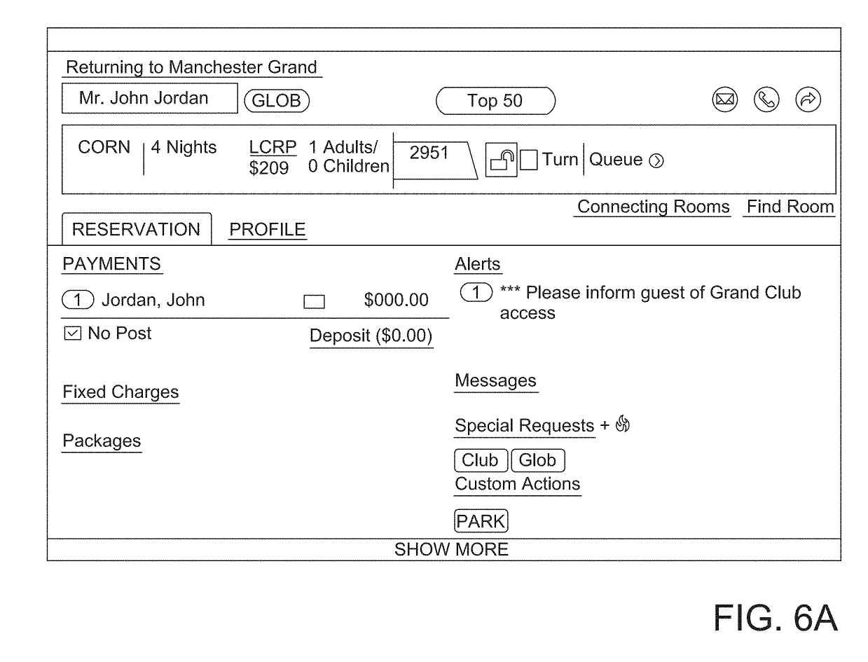

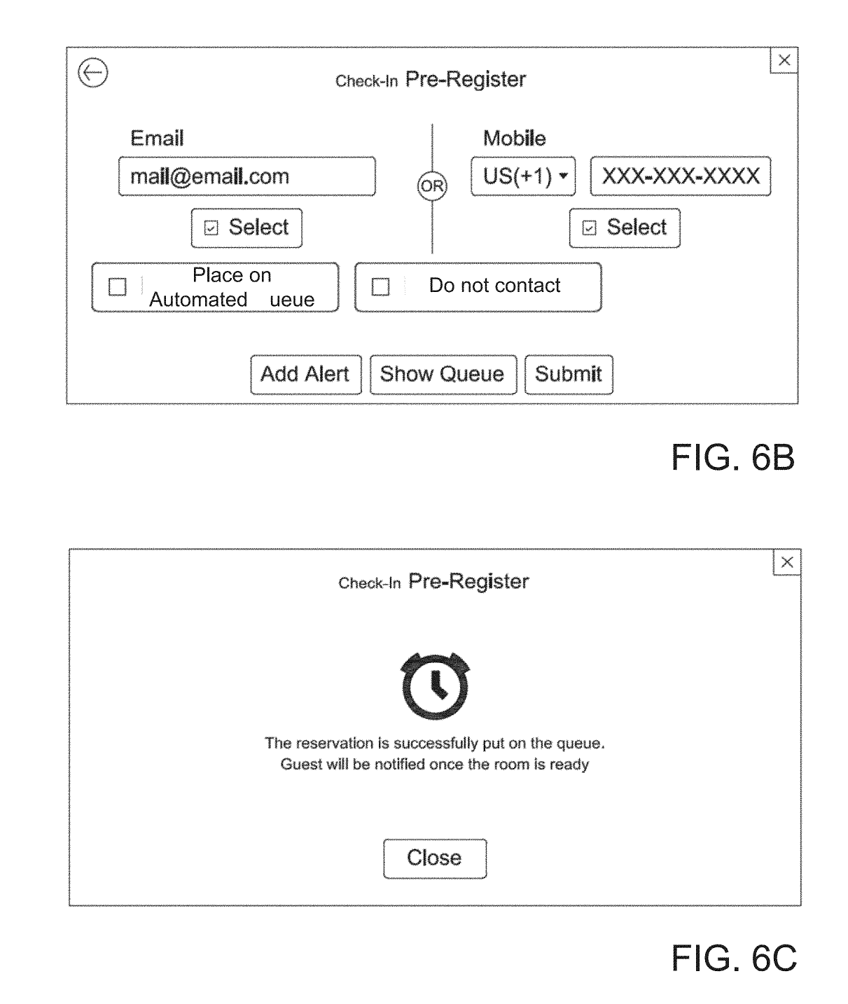

In yet a further aspect of the application, FIG. 6A illustrates an application including a GUI whereby a host can place a guest in an automated queue when no rooms are currently available, or alternatively, when the assigned room is not yet available. The queue allows for pre-registration. That is, a room can be selected and offered to a customer upon being made available. The pre-registration may be made for specific dates, for a specific number of guests, or for a specific place of hospitality. The pre-registration may be made for a room type, such as a room with a specific number of beds, size of beds, amenities, or location at the place of hospitality. A deposit may be made for the pre-registration. Payment for the room may be processed upon a room becoming available. The GUI may also include alerts including instructions, custom actions, e.g., a parking option, messages, packages e.g., deals on rooms, food, and special amenities, and special requests.

As illustrated in FIG. 6B, the next screen offers an option of choosing whether the host wishes to enter an automatic queue. The automatic queue option is activated when the host clicks on a Place on Automatic Queue button. The host may provide additional contact information of either an email or phone number may be input. FIG. 6B also offers an option of not being contacted. As illustrated in FIG. 6B, the host provides an email address for being contacted. FIG. 6C confirms that the reservation has been put in a queue and that the guest will be notified once the room is ready.

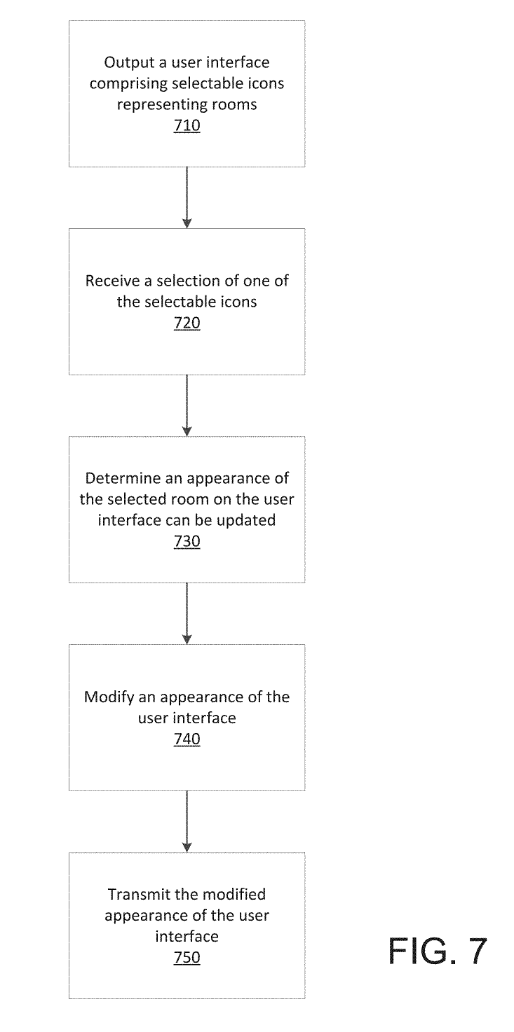

FIG. 7 exemplarily illustrates a method of checking in and out guests, such as at a place of hospitality or lodging. At step 710, a user interface may be output. The user interface may be like any of the GUI's shown in FIGS. 2-6. The user interface may comprise selectable icons representing rooms at a place of hospitality, such as shown in FIG. 3. Room criteria may be received. The user interface may comprise selectable icons representing rooms that meet the received criteria. The user interface may show locations of the rooms at the place of hospitality.

The user interface may be output via a first device. The first device may be located at the place of hospitality, such as for example, at a front desk. The first device may be similar to the M2M device 30 shown in FIG. 1. The first device may be part of a computing system, such as the computing system 90 shown in FIG. 1B. The first device may be a reservation system server. The reservation system server may be in communication with reservation system devices, such as devices located at the place of hospitality and devices of guests of the place of hospitality. The first device may be located external to the place of hospitality.

At step 720, a selection of one of the selectable icons representing rooms may be received. The selection of the icon may be received via the first device. The selection of the icon may be received from a second device. The second device may be a user device, such as a device of a guest of the place of hospitality.

At step 730, it may be determined that an appearance of the selected room on the user interface can be updated. The first device may determine that the appearance of the selected room on the user interface can be updated. It may be determined that the appearance of the selected room on the user interface can be updated based on receiving the selection of the icon in step 720.

At step 740, an appearance of the user interface may be modified. The appearance of the user interface may be modified to show the selected room is locked. The appearance of the user interface may be modified based on determining the appearance of the selected room on the user interface can be updated in step 730. The modified appearance may show locations of the rooms at the place of hospitality. The appearance of the user interface may be modified by the first device.

At step 750, the modified appearance of the user interface including the locked room may be transmitted. The modified appearance of the user interface may be transmitted via the second device. The modified appearance of the user interface may be transmitted to a plurality of devices, such as devices in the network or associated with the reservation system. As an example, the modified appearance may be transmitted to devices at check-in desks at the place of hospitality. The appearance of the user interface may be synchronized across the devices.

The locked room may be associated with a reservation or an account of a guest. The locked room may be pending reservation. The locked room may not be selected and may be held for the account or guest, such as until the reservation is completed, payment is processed, or information associated with a user is received. For example, the locked room may be added to a virtual shopping cart. The locked room may remain in the virtual shopping cart until confirmation of reservation of the room is received or payment for the reservation is processed. The locked room may be unlocked, such as based on a logging-off of a device or account or after an idle period on a device, after which the reservation system may time-out.

A selection of the selectable icon representing the locked room may be received from a third device. An error message may be sent to the third device based on the room being locked or based on the selection of the icon by the second device.

The appearance of the user interface may be further modified. For example, the appearance of the user interface may be modified based on receiving a selection of another of the selectable icons representing another room. The appearance of the user interface may be modified to show the other room is locked. The appearance of the user interface may be modified to show the originally selected room is unlocked. The appearance of the user interface may be modified to show the selected room is unlocked after a predetermined period of time, such as after receiving the selection of the selectable icon representing the room or after the modifying the appearance of the user interface showing the selected room is locked. The predetermined time may comprise a period of five minutes, ten minutes, fifteen minutes, or another period of time. The appearance of the user interface may be modified to show the selected room is unlocked based on a logging-off of the reservation system, such as by the second device.

Room criteria may be received. The criteria may comprise a room type, such as a suite, a room with a number of beds, e.g., one bed, two beds, etc., a room with a bed of a particular size, e.g., queen bed, king bed, double bed, etc., a smoking or non-smoking room, or a handicap accessible room, as examples. The criteria may comprise a location of the room, such as a floor of the place of hospitality, a room with a view, e.g., of a street, a pool, a beach, etc., a room adjacent a pool, or a room adjacent or across from an elevator, as examples. The criteria may comprise an amenity, such as a room with a kitchenette, a room with a bathtub, or a room with a balcony. The criteria may comprise a price of the room. The locked room may remain on-hold while a room that satisfies the criteria may be determined. The appearance of the user interface may be modified to show the room that satisfies the criteria.

The method may include receiving information associated with a guest of the place of hospitality. The locked room may be reserved for the guest. Payment information may be received. The locked room may be reserved based on receiving the payment information. The appearance of the user interface may be modified to show that the room has a pending reservation by a guest.

As an illustrative example, a guest may check-in at a front desk at a hotel. The host may enter a name of the guest in a user interface. The user interface may show a reservation of the guest. A room at the hotel may not be assigned to the reservation. The user interface may show selectable icons representing available rooms at the place of hospitality. The user interface may show icons representing locked rooms, such as rooms at the place of hospitality that are pending booking. The locked icons may not be selectable. For example, the locked icons may not be depressed or engaged. An attempt at selecting a locked icon may result in an error message. The locked icons may inform the host that, at the time, the host cannot select one of the locked rooms for the guest. The locked icons may inform the host that another guest is in the process of booking one of the locked rooms.

The user interface may show icons representing reserved or booked rooms. The booked icons may inform the host that the booked rooms cannot be assigned to the guest or reservation. The booked icons may inform the host that booking of the rooms has been finalized or processed. The icons associated with the booked rooms may not be selected.

The host may select one of the selectable icons representing a room. The room may be locked. Before finalizing the booking, the host may view the rooms and choose another room to add to the reservation.

Another host using a different device may be viewing a user interface showing rooms at the hotel. The user interface may be updated to show that the room selected by the first host is locked. The representation of the selected room as locked may inform the other host that the room is in the process of being booked, but that the booking has not been finalized. The representation of the selected room as locked my inform the other host that the room may not be locked or assigned to another guest or reservation.

Once the first host selects the second room, the host may finalize the guest's booking. The host may enter payment information or a confirmation of the booking. After the booking is processed, the user interface may refresh and show the two rooms are no longer locked, but are booked. The other host may see a user interface with a same appearance. For example, the appearance of the user interface may be synchronized across devices.

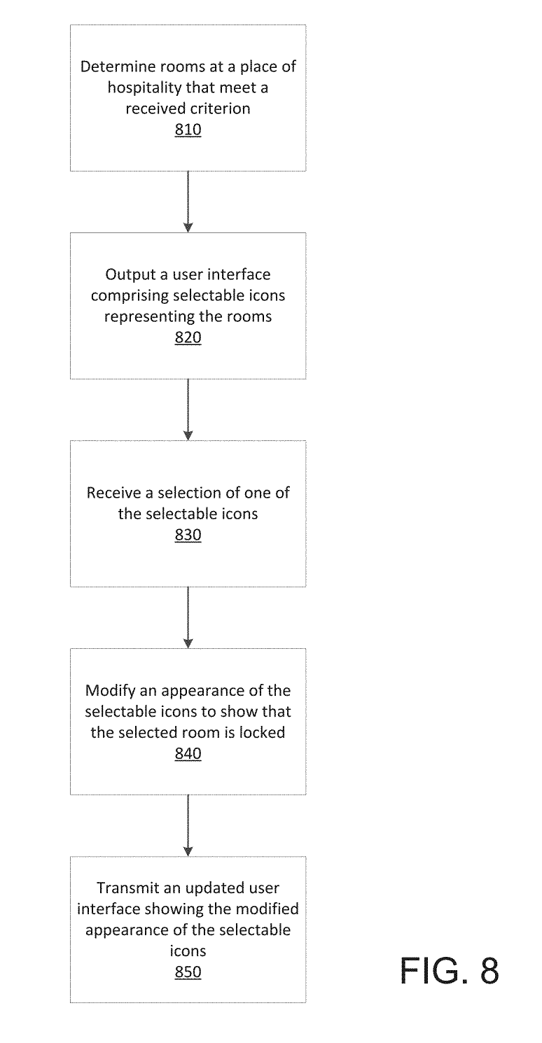

FIG. 8 exemplarily illustrates a method of checking in and out guests. At step 810, it may be determined that rooms at a place of hospitality meet a received criterion. The criterion may comprise a room type, such as a suite, a two bed room, a queen bed room, a smoking or non-smoking room, or a handicap accessible room, as examples. The criterion may comprise a location of the room, such as a floor of the place of hospitality, a room with a view, e.g., of a street, a pool, a beach, etc., a room adjacent a pool, or a room adjacent or across from an elevator, as examples. The criterion may comprise an amenity, such as a room with a kitchenette, a room with a bathtub, or a room with a balcony.

The criterion may be received via a first device. The criterion may be received from a second device. The first device may determine which rooms at the place of hospitality meet the received criterion.

At step 820, a user interface comprising selectable icons representing rooms at the place of hospitality may be output. The icons may represent the rooms determined to meet the received criterion. The user interface may show locations of the rooms at the place of hospitality. The user interface may be output by the first device. The user interface may be displayed via the second device.

At step 830, a selection of one of the selectable icons may be received. The selection of the selectable icon may be receive via the first device. The selection of the selectable icon may be received from the second device.

At step 840, an appearance of the selectable icons may be modified. The appearance of the selectable icons may be modified to show that the selected room is locked. The modified appearance of the user interface may show locations of the rooms at the place of hospitality. The appearance of the selectable icons may be modified by the first device.

At step 850, an updated user interface showing the modified appearance of the selectable icons may be transmitted. The updated user interface may be transmitted to the second device. The updated user interface may be transmitted by the first device. The modified appearance of the user interface may be transmitted to a plurality of devices, such as devices in the network or associated with the reservation system. As an example, the modified appearance may be transmitted to devices at check-in desks at the place of hospitality.

A reservation associated with the place of hospitality may exist. For example, a guest may have made a reservation to stay at the place of hospitality. However, a room may not have been assigned to the reservation. The reservation may have a price. The user interface may indicate one or more rooms that exceed the price. The user interface may include a selectable option to assign the rooms that exceed the price for an upcharge.

A selection of the selectable icon representing the locked room may be received from a third device. An error message may be sent to the third device based on the room being locked or based on the selection of the icon by the second device.

The appearance of the user interface may be further modified. For example, the appearance of the user interface may be modified based on receiving a selection of another of the selectable icons representing another room. The appearance of the user interface may be modified to show the other room is locked. The appearance of the user interface may be modified to show the originally selected room is unlocked. The appearance of the user interface may be modified to show the selected room is unlocked after a predetermined period of time, such as after receiving the selection of the selectable icon representing the room or after the modifying the appearance of the user interface showing the selected room is locked. The predetermined time may comprise a period of five minutes, ten minutes, fifteen minutes, or another period of time. The appearance of the user interface may be modified to show the selected room is unlocked based on a logging-off of the reservation system, such as by the second device.

The method may include a step of receiving information associated with a guest of the place of hospitality. The locked room may be reserved for the guest. Payment information may be received. The locked room may be reserved based on receiving the payment information. The appearance of the user interface may be modified to show that the room has a pending reservation by a guest.

As an illustrative example, a guest may check-in at a front desk at a hotel. The host my view enter a name of the guest in a user interface. The user interface may show a reservation of the guest. A room at the hotel may not be assigned to the reservation. The reservation may have criteria, such as a room with a balcony and a queen size bed. The user interface may show available rooms at the place of hospitality that meet the criteria. The guest may inform the host that she also has a preference for a room with that is adjacent a room with an unlockable door joining the rooms. The host may enter in the criteria. The appearance of the user interface may refresh to show rooms that meet the criteria of the reservation, as well as the new criteria. The host may select one of the rooms. The room may be locked. Before finalizing the booking, the host may view the rooms and choose a room adjacent the selected room.

Another host using a different device may be viewing a user interface showing rooms at the hotel. The user interface may be updated to show that the room selected by the first host is locked. The representation of the selected room as locked may inform the other host that the room is in the process of being booked, but that the booking has not been finalized. The representation of the selected room as locked my inform the other host that the room may not be locked or assigned to another guest or reservation.

Once the first host selects the second room, the host may finalize the guest's booking. The host may enter payment information or a confirmation of the booking. After the booking is processed, the user interface may refresh and show the two rooms are no longer locked, but are booked. The other host may see a user interface with a same appearance. For example, the appearance of the user interface may be synchronized across devices.

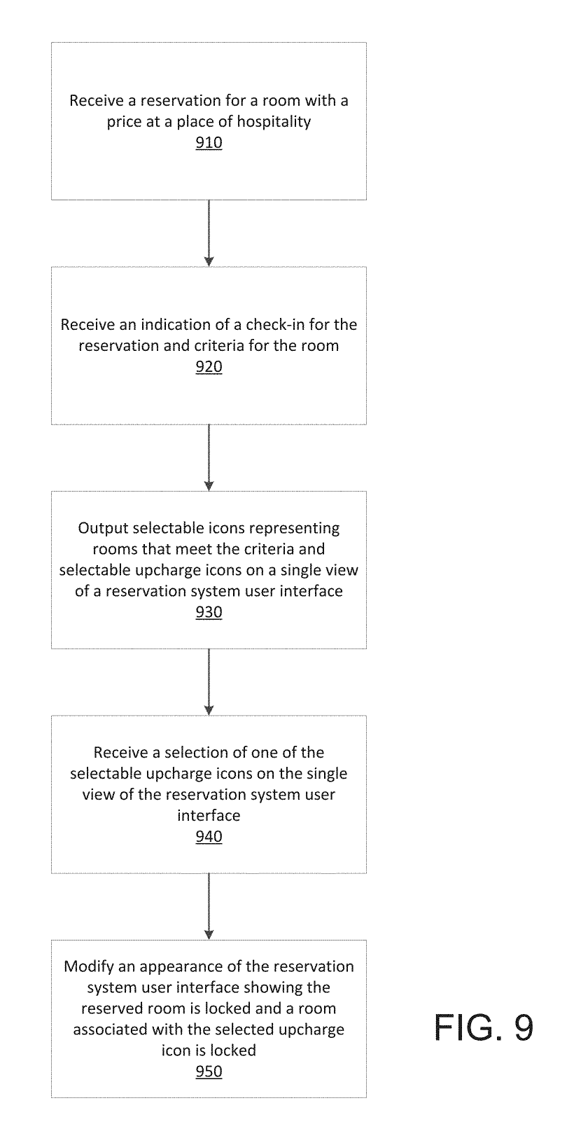

FIG. 9 exemplarily illustrates a method of checking in and out guests. At step 910, a reservation for a room at a place of hospitality may be received. The reservation may have a price. The reservation may be received by a first device. The reservation may be received from a second device.

At step 920, an indication of a check-in for the reservation may be received. The indication of the check-in may be received via the first device. The indication of the check-in may be received from the second device. Criteria associated with the reservation for a room at the place of hospitality may be received. The criteria may comprise a room type, such as a suite, a two bed room, a queen bed room, a smoking or non-smoking room, or a handicap accessible room, as examples. The criteria may comprise a location of the room, such as a floor of the place of hospitality, a room with a view, e.g., of a street, a pool, a beach, etc., a room adjacent a pool, or a room adjacent or across from an elevator, as examples. The criteria may comprise an amenity, such as a room with a kitchenette, a room with a bathtub, or a room with a balcony. The criteria may be received via the first device. The criteria may be received from the second device.

At step 930, selectable icons representing rooms at the place of hospitality that meet the criteria may be output on the reservation system user interface. Selectable upcharge icons for each of the rooms may be output on the reservation system user interface. Rooms that do not meet the criteria may be represented by non-selectable icons, such as an icon that cannot be engaged. The reserved room, the selectable icons representing rooms that meet the criteria, and the selectable upcharge icons may be output on a single view of the reservation system user interface. Locations of the rooms at the place of hospitality may be output on the single view of the reservation system user interface. The icons may be output by the first device. The icons may be displayed on the second device.

At step 940, a selection of one of the selectable upcharge icons may be received. The selection of the upcharge icon may be receive via the single view of the reservation system user interface. The selection of the charge icon may be received via the first device. The selection of the charge icon may be received from the second device.

At step 950, an appearance of the reservation system user interface may be modified. The appearance of the reservation system user interface may be modified to show the reserved room is locked. The appearance of the reservation system user interface may be modified to show a room associated with the selected upcharge icon is locked. The modified appearance of the user interface may show locations of the rooms at the place of hospitality. The modified appearance of the user interface may show the elements via the single view. The appearance may be modified by the first device.

The modified appearance of the reservation system user interface may be transmitted to the second device. The modified appearance of the reservation system user interface may be displayed via the second device. The modified appearance of the reservation system user interface may be transmitted to a plurality of devices, such as devices in the network or associated with the reservation system. As an example, the modified appearance may be transmitted to devices at check-in desks at the place of hospitality.

A selection of the selectable icon representing the locked room may be received from a third device. An error message may be sent to the third device based on the room being locked or based on the selection of the icon by the second device.

The appearance of the user interface may be further modified. For example, the appearance of the user interface may be modified based on receiving a selection of another of the selectable icons representing another room or another of the upcharge icons. The appearance of the user interface may be modified to show the other room is locked. The appearance of the user interface may be modified to show the originally selected room is unlocked. The appearance of the user interface may be modified to show the originally selected room is unlocked based on receiving criteria not satisfied by the selected room. The appearance of the user interface may be modified to show the selected room is unlocked after a predetermined period of time, such as after receiving the selection of the selectable icon representing the room or after the modifying the appearance of the user interface showing the selected room is locked. The predetermined time may comprise a period of five minutes, ten minutes, fifteen minutes, or another period of time. The appearance of the user interface may be modified to show the selected room is unlocked based on a logging-off of the reservation system, such as by the second device.

The method may include receiving information associated with a guest of the place of hospitality. The locked room may be reserved for the guest. Payment information may be received. The locked room may be reserved based on receiving the payment information. The appearance of the user interface may be modified to show that the room has a pending reservation by a guest.

As an illustrative example, a guest may check-in at a front desk at a hotel. The host may enter a name of the guest in a user interface. The user interface may show a reservation of the guest. A room at the hotel may not be assigned to the reservation. The reservation may have a criteria. The reservation may have a price. The user interface may show available rooms at the place of hospitality that meet the criteria. The user interface may show upcharge icons next to available rooms that have prices exceeding the price associated with the reservation.

The host may select one of the rooms. To select one of the rooms with a price that exceeds the price associated with the reservation, the host may select an upcharge icon corresponding to the room. The user interface may refresh to show the room is locked. The host may finalize booking the room, such as by confirming the reserving of the room or by entering payment information. The user interface may refresh to show the room is reserved.

While the systems and methods have been described in terms of what are presently considered to be specific aspects, the application need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed:

1. A method comprising:
outputting, via a first device, a user interface of a reservation system comprising selectable icons representing rooms at a place of hospitality;
receiving, via the first device, a selection of one of the selectable icons representing one of the rooms;
determining an appearance of the selected room on the user interface can be updated;
modifying, based on the determining step, the appearance of the selected room on the user interface with a locked status; and
transmitting, via a second device, the modified appearance of the user interface including the locked room.

2. The method of claim 1, wherein the user interface shows the selected room with the locked status for a predetermined period of time.

3. The method of claim 1, further comprising:
receiving a selection of another selectable icon representing another room; and
updating the appearance of the user interface showing the selected room with an unlocked status.

4. The method of claim 3, further comprising:
modifying the appearance of the user interface with the locked status for the another room.

5. The method of claim 1, further comprising:
receiving information of a guest; and
reserving, based on the selection, the selected room for the guest.

6. The method of claim 1, further comprising:
receiving room criteria;
determining at least one room at the place of hospitality that satisfies the room criteria; and
modifying the appearance of the user interface showing the selected room and the at least one room with the locked status.

7. The method of claim 1, further comprising:
modifying the appearance of the user interface showing the selected room is reserved based on receiving payment information.

8. The method of claim 1, wherein the modified appearance of the user interface shows locations of the rooms at the place of hospitality.

9. The method of claim 1, further comprising:
receiving, via the second device, a selection of another of the selectable icons representing another of the rooms; and
modifying the appearance of the user interface showing the another room with the locked status and the selected room with an unlocked status.

10. A reservation system server in a network comprising:
a processor; and
a non-transitory memory storing instructions that, when executed by the processor, cause the reservation system server to:
determine, based on a received criterion, rooms at a place of hospitality that meet the criterion;
output a user interface on a display comprising selectable icons representing the rooms;
receive, from a device in the network configured to handle reservations, a selection of one of the selectable icons representing one of the rooms;
modify an appearance of the selectable icons to show that the selected room is locked; and
send, to the device, an updated user interface showing the modified appearance of the selectable icons.

11. The reservation system server of claim 10, wherein the instructions, when executed, further cause the reservation system server to:
detect the device has logged off the reservation system; and
update the appearance of the user interface showing the selected room is unlocked based on the detection.

12. The reservation system server of claim 10, wherein the instructions, when executed, further cause the reservation system server to:
receive, from a second device in the network, a selection of the one of the selectable icons; and
transmit, to the second device, an error message based on the selection of the one of the selectable icons received from the device.

13. The reservation system server of claim 10, wherein the instructions, when executed cause the reservation system server to send the updated user interface by sending the updated user interface to a plurality of devices in the network.

14. The reservation system server of claim 10, wherein the modified appearance of the selectable icons comprises an icon indicating the selected room has a pending reservation by a guest.

15. The reservation system server of claim 10, wherein the criterion comprises one or more of a room location, a size of a bed in the room, a price, and a number of beds in the room.

16. The reservation system server of claim 10, wherein
an existing reservation is associated with the place of hospitality,
the user interface indicates one or more of the rooms that exceed a price associated with the reservation, and
the user interface indicates a selectable option to assign the one or more of the rooms for an upcharge.

17. A method comprising:
receiving, by a computing device, a reservation for a first room with a price at a place of hospitality;
receiving, by the computing device, an indication of a check-in for the reservation by a guest and criteria for the room;
outputting, on a single view of a reservation system user interface on the computing device, the first room with a locked status and selectable icons representing other, unreserved rooms at the place of hospitality that meet the criteria with each unreserved room including a selectable upcharge icon;
receiving, by the computing device, a selection of one of the selectable upcharge icons on the single view of the reservation system user interface; and
modifying an appearance of the reservation system user interface showing the room associated with the selected upcharge icon with the locked status.

18. The method of claim 17, wherein the user interface further displays non-selectable icons representing rooms at the place of hospitality that do not meet the criteria.

19. The method of claim 17, wherein the criteria comprises one or more of a suite room, a floor of the place of hospitality, and a room next to an elevator.

20. The method of claim 17, further comprising modifying the appearance of the user interface showing the first room with an unlocked status based on receiving criteria not satisfied by the first room.
